(19) United States
(12) Patent Application Publication
(10) Pub. No.: US 2003/0059170 A1
(43) Pub. Date: Mar. 27, 2003

(54) SPLIT SLEEVE PREFORM

(76) Inventors: SETSUO SHOUJI, TOKYO (JP); MASAHIKO TSUNEMI, TOKYO (JP)

Correspondence Address: ADAMS & WILKS, 31ST FLOOR, 50 BROADWAY, NEW YORK, NY, 10004

(21) Appl. No.: 09/035,478

(22) Filed: Mar. 5, 1998

(30) Foreign Application Priority Data
Mar. 6, 1997 (JP) 9-052145

(51) Int. Cl. G02B 6/38

(52) U.S. Cl. 385/72

(57) ABSTRACT

A split sleeve material is generally in a cylindrical form to have penetrating grooves extending in an axial direction and, at respective end portions, annular end portions where the penetrating groove is not formed over an entire periphery thereof. A split sleeve is formed by cutting the annular end portions.

### BACKGROUND OF THE INVENTION

This invention relates to a split sleeve material a split sleeve and a method of manufacturing a split sleeve. The split sleeve material is used to make the split sleeve. The split sleeve is adapted to connect two ferrules which hold optical fibers in their central axes.

Conventionally, split sleeves 100 as shown in FIG. 5 are being used to easily photo-coupling to each other ferrules for holding an optical fiber, or the like. The split sleeve 100 as shown in FIG. 5 is made of ceramics such as zirconia, which is usually formed by sintering a cylindrical body and then lapping an inner surface and then forming a slit 101 by grinding.

However, there is a problem that, since the ceramics such as zirconia is very high in hardness, it takes much labor to form the slit 101 by grinding.

On the other hand, there is another problem that, if the slit 101 is formed from a sintering stage, the entire shape is deformed.

Also, there is a problem that the shape having one strip of a slit 101 provided in the cylindrical body as above tends to cause variations in inner diameter dimension and there is a fear that the center somewhat deviates to degrade in alignment stability. Therefore, for example, the coupling loss becomes large where coupling between ferrules holding an optical fiber. The present invention has been made in view of such situations, and it is the object to provide a split sleeve material easy to manufacture and by which a split sleeve excellent in alignment stability is obtainable, and split sleeve, and a method of manufacturing a split sleeve.

### SUMMARY OF THE INVENTION

A split sleeve material, that solves the above problem, adapted for forming a split sleeve for fitting rod members therein from respective sides to thereby place the rod members at their tip surfaces in abutment against each other, characterized in that: the split sleeve material is generally in a cylindrical form to have at least one strip of a penetrating groove extending in an axial direction and, at respective end portions, annular end portions where the penetrating groove is not formed over an entire periphery thereof.

Here, the penetrating groove is, for example, one strip of a groove extending between the respective annular portions at the respective end portions.

Also, for example, the penetrating groove is a plurality of strips in number, the respective of which extend to only one of the annular end portions at the respective end portions.

The split sleeve material of the invention is for being formed into a split sleeve by cutting the annular end portions.

A split sleeve of the present invention adapted for fitting rod members therein from respective sides to thereby place the rod members at their tip surfaces in abutment against each other, characterized in that: the split sleeve is generally in a cylindrical form to have at least one strip of a penetrating groove extending in an axial direction and an opening end face of the penetrating groove formed by sintering. Here, the penetrating groove is one strip groove that extends in an axial direction to attain to the respective end portions.

Also, for example, the penetrating groove is a plurality of strips in number, the respective of which extend to only one of the annular end portions at the respective end portions.

A method of manufacturing a split sleeve adapted for fitting therein rod members from respective sides to thereby place the rod members at their tip surfaces in abutment against each other, characterized by comprising: a process of sintering a split sleeve material that is generally in a cylindrical form to have at least one strip of a penetrating groove extending in an axial direction and, at respective end portions, annular end portions where said penetrating groove is not formed over an entire periphery thereof; and a process of cutting respective annular end portions of the split sleeve material to open an axial end portion of the penetrating groove to be formed into a split sleeve.

### BRIEF DESCRIPTION OF THE DRAWINGS

FIGS. 1A and 1B are perspective views of a split sleeve material and a split sleeve according to an embodiment 1 of the present invention.

FIGS. 2A and 2B are perspective views of a split sleeve material and a split sleeve according to an embodiment 2 of the present invention.

FIGS. 3A and 3B are perspective views of a split sleeve material and a split sleeve according to an embodiment 3 of the present invention.

FIGS. 4A and 4B are perspective views of a split sleeve material and a split sleeve according to an embodiment 4 of the present invention.

FIG. 5 is a perspective view of a split sleeve according to the conventional art.

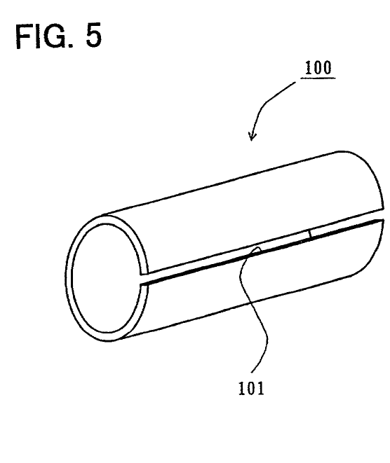

### DETAILED DESCRIPTION OF THE INVENTION

Explanations will be made hereinbelow on embodiments of the present invention by the drawings.

(Embodiment 1)

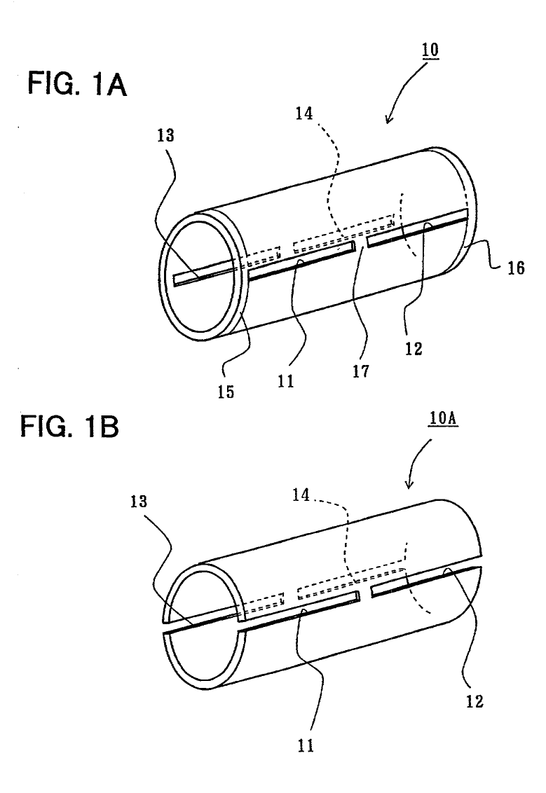

FIG. 1A is a perspective view of a split sleeve material according to a present embodiment, while FIG. 1B is a perspective view of a sleeve obtained from the same sleeve material.

As shown in FIG. 1A, the split sleeve material 10 of the present embodiment has substantially a cylindrical shape formed with axially-extending penetrating grooves 11-14 respectively at circumferentially opposite two locations thereof. These penetrating grooves 11-14 are not formed up to the respective axial end portions. At respective end portions of the split groove material 10, annular end portions 15 and 16 are provided where no penetrating groove 11-14 is formed in its circumferential direction. An annular portion 17 is also formed at an axially central portion so that the annular portion 17 is positioned between the penetrating groove 11, 13 and the penetrating groove 12, 14.

The split sleeve material 10 like this employs, as a material, yttria-added partially-stabilized zirconia (ZrO₂. Y₂O₃ (Y₂O₃: contained by 3% in mol) which is temporarily formed in a shape as stated above and thereafter formed, for example, by heating at 150° C. and further sintered at a high temperature of approximately 1500° C. Incidentally, the inner peripheral surface may be lapped as required after sintering. Also, there is no necessity of grinding an opening end face of the penetrating groove 11-14 so that it may be in a sintered skin as it is without necessity of grinding.

The split sleeve material 10 of FIG. 1A is formed into a split sleeve 10A as shown in FIG. 1B by cutting the annular end portions 15 and 16 at the respective ends to open one end of each of the penetrating grooves.

This split sleeve 10A has the penetrating grooves arranged symmetrical in the circumferential direction and the axial direction so that it is extremely high in alignment stability. Also, the split groove 10A like this is very difficult to form by the method of cutting the slits by grinding as the conventional.

(Embodiment 2)

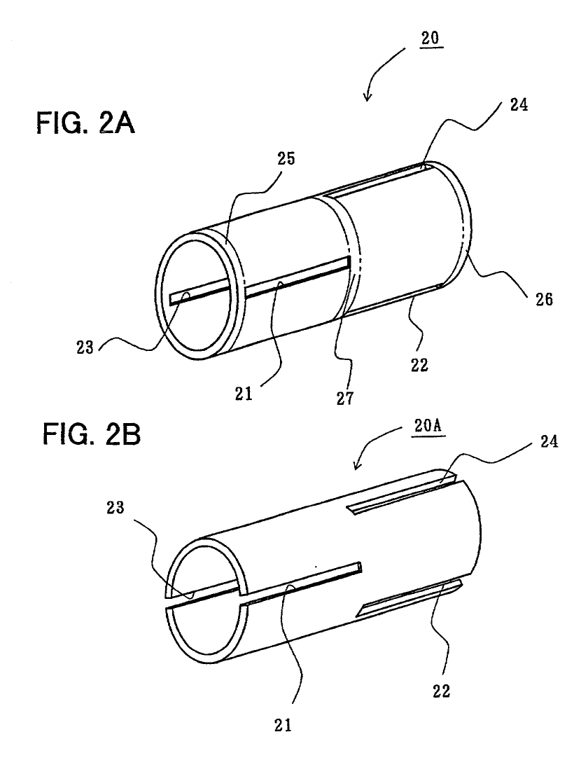

FIG. 2A is a perspective view of a split sleeve material according to a present embodiment, while FIG. 2B is a perspective view of a sleeve obtained from the same sleeve material.

As shown in FIG. 2A, the sleeve material 20 of the present embodiment has substantially a cylindrical shape formed with axially-extending penetrating grooves 21-24 respectively at circumferentially opposite two locations. At respective end portions and an axially central portion, annular end portions 25, 26 and 27 are provided that are not formed with the penetrating groove 21-24 in the circumferential direction. Here, the penetrating grooves 22 and 24 adjacent the annular end portion 26 are opposite in a diametrical direction but the penetrating grooves 21-24 are deviated therebetween by 90 degrees in the circumferential direction.

The split sleeve material 20 of FIG. 2A is formed into a split sleeve 20A as shown in FIG. 2B by cutting the annular end portions 25 and 26 at the respective ends to open one end of each of the penetrating grooves.

This split sleeve 20A has the penetrating grooves arranged symmetrical in the circumferential direction and further in the axial direction so that it is extremely high in alignment stability. Also, the split groove 20A like this is very difficult to form by a method of cutting the slits by grinding as the conventional.

(Embodiment 3)

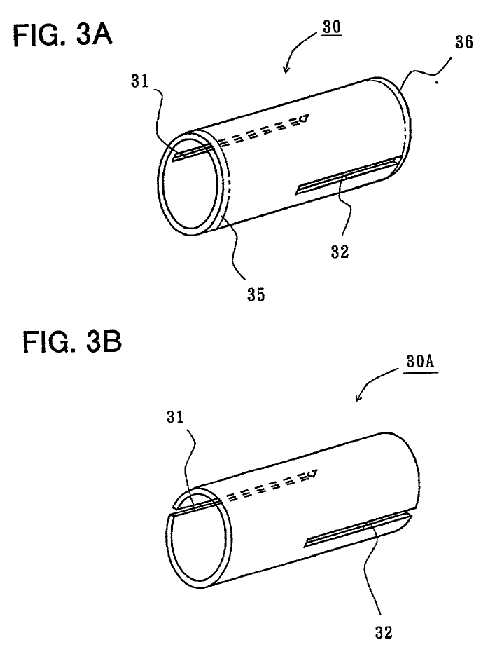

FIG. 3A is a perspective view of a split sleeve material according to a present embodiment, while FIG. 3B is a perspective view of a sleeve obtained from the same sleeve material.

As shown in FIG. 3A, the sleeve material 30 of the present embodiment has substantially a cylindrical shape formed with axially-extending penetrating grooves 31 and 32 respectively extending in the axial direction at circumferentially opposite two locations. At respective end portions, annular end portions 35 and 36 are provided that are not formed with the penetrating groove 31 and 32 in the circumferential direction. Here, the penetrating grooves 31 and 32 are formed at locations opposite in a diametrical direction, but the penetrating groove 31 adjacent the annular end portion 35 is not extended up to the annular groove 36 and the penetrating groove 32 adjacent the annular end portion 36 is not extended up to the annular portion 35. However, the penetrating grooves 31 and 32 are overlapped with each other in the axially central portion so that no annular portion is provided at the central portion. The split sleeve material 30 of FIG. 3A is formed into a split sleeve 30A as shown in FIG. 3B by cutting the annular end portions 35 and 36 at the respective ends to open one end of each of the penetrating grooves.

This split sleeve 20A has the penetrating grooves arranged symmetrical in the circumferential direction and the axial direction so that it is extremely high in alignment stability. Also, the split groove 20A like this is very difficult to form by making the slits through grinding as the conventional.

This split sleeve 30A is wholly symmetrical in arrangement of the penetrating grooves, and very high in alignment stability. Also, the split sleeve 30A like this is difficult to form by the method of cutting a slit by grinding as the conventional.

(Embodiment 4)

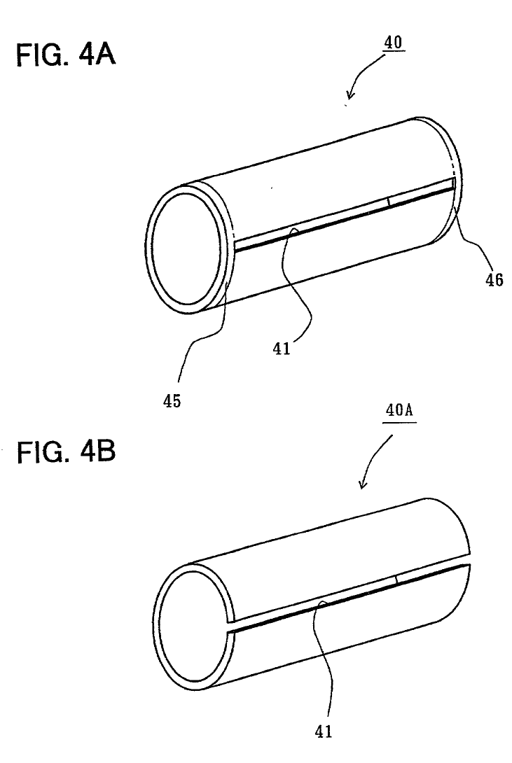

FIG. 4A is a perspective view of a split sleeve material according to a present embodiment, while FIG. 4B is a perspective view of a sleeve obtained from the same sleeve material.

As shown in FIG. 4A, the split sleeve material 40 of the present embodiment has substantially a cylindrical shape formed with an axially-extending penetrating groove 41 respectively extending in the axial direction at a circumferentially one location. At respective end portions, annular end portions 45 and 46 are provided that are not formed with the penetrating groove 45 and 46 in the circumferential direction. The split sleeve material 40 of FIG. 4A is formed into a split sleeve 40A as shown in FIG. 4B by cutting the annular end portions 35 and 36 at the respective ends to open one end of each of the penetrating grooves.

Although this split sleeve 40A is similar in shape to the conventional one. However, the manufacturing method is quite different and so that an effect is provided that is easy to manufacture as compared to the conventional.

As stated above, according to the present invention, since the penetrating groove of the split groove is formed during sintering, the manufacture is very easy as compared to the conventional. Further, a symmetrical form of a split sleeve can be made, which is accordingly excellent in alignment stability.

What is claimed is:

1. A split sleeve material for forming a split sleeve adapted for fitting rod members therein from respective sides to thereby place said rod members at their tip surfaces in abutment against each other, characterized in that: said split sleeve material is generally in a cylindrical form to have at least one strip of a penetrating groove extending in an axial direction and, at respective end portions, annular end portions where said penetrating groove is not formed over an entire periphery thereof.

2. In claim 1, a split sleeve material characterized in that said penetrating groove is one strip groove extending between the annular end portions at said respective ends.

3. In claim 1, a split sleeve material characterized in that said penetrating groove is a plurality of strips in number, the respective of which attain to only one of said annular end portions at the respective end portions.

4. A split sleeve material according to claim 1 wherein said sleeve material is formed into a split sleeve by cutting said annular end portions.

5. A split sleeve adapted for fitting rod members therein from respective sides to thereby place said rod members at their tip surfaces in abutment against each other, characterized in that: said split sleeve is generally in a cylindrical form to have at least one strip of a penetrating groove extending in an axial direction and an opening end face of said penetrating groove formed by sintering.

6. In claim 5, a split sleeve characterized by said penetrating groove is one strip groove that extends in an axial direction to attain to said respective end portions.

7. In claim 5, a split sleeve characterized in that said penetrating groove is a plurality of strips in number, the respective of which attain to only one of said annular end portions at said respective end portions.

8. A method of manufacturing a split sleeve adapted for fitting rod members therein from respective sides to thereby place said rod members at their tip surfaces in abutment against each other, characterized by comprising: a process of sintering a split sleeve material that is generally in a cylindrical form to have at least one strip of a penetrating groove extending in an axial direction and, at respective end portions, annular end portions where said penetrating groove is not formed over an entire periphery thereof; and a process of cutting respective annular end portions of said split sleeve material to open an axial end portion of said penetrating groove to be formed into a split sleeve.
